(19) United States
(12) Patent Application Publication
(10) Pub. No.: US 2008/0318693 A1
(43) Pub. Date: Dec. 25, 2008

(54) Longitudinal shaft

(76) Inventors: Gerald Langer, Bulstringen (DE); John Sherlock, Wolverhampton (GB)

Correspondence Address: COLLARD & ROE, P.C., 1077 NORTHERN BOULEVARD, ROSLYN, NY, 11576, US

(21) Appl. No.: 12/214,431

(22) Filed: Jun. 19, 2008

(30) Foreign Application Priority Data
Jun. 21, 2007 (DE) DE102007029112.6
May 27, 2008 (DE) DE102008025238.7

(51) Int. Cl. F16D 3/20

(52) U.S. Cl. 464/162

(57) ABSTRACT

A longitudinal shaft for use in motor vehicles consists of a tubular part having joints on both ends, corresponding to a differential side and a transmission side. There is a differential shaft and a transmission shaft accommodated on the two ends. The two joints are disposed in accommodation regions provided on the two ends of the tubular part by way of their outer hubs in a torque-proof manner. The joints are configured as a displacement joint or as a fixed joint, which can be disposed in the tubular part of the longitudinal shaft in the combination of two displacement joints, one displacement joint and one fixed joint, or two fixed joints with displacement.

### CROSS REFERENCE TO RELATED APPLICATIONS

Applicants claim priority under 35 U.S.C. 119 of German Application No. 10 2007 029 112.6 filed Jun. 21, 2007 and German Application No. 10 2008 025 238.7 filed May 27, 2008.

### BACKGROUND OF THE INVENTION

1. Field of the Invention

The invention relates to a longitudinal shaft, particularly for use in motor vehicles, which is configured with joints on the transmission side and on the differential side. The terms “on the transmission side” and “on the differential side” are used purely as examples, in the sense of the invention, to differentiate the two ends of the longitudinal shaft.

2. The Prior Art

With motor vehicles that have an engine with a transmission in the front region of the motor vehicle, the drive torque of the engine for the rear wheel drive is transferred to the rear differential transmission by way of a longitudinal shaft/articulated shaft disposed in the direction of travel.

Longitudinal shafts configured in this manner are usually attached to the transmission output shaft and the differential input shaft, respectively, by way of a flange connection with the outer rings of the joint on the transmission side and of the joint on the differential side, in torque-proof manner.

A device for connecting a constant velocity joint with a shaft, in which the constant velocity joint has an inner joint part and an outer joint part, between which balls guided in a ball cage and transferring torque are disposed, is described in German Patent No. DE 197 15 852 B4. In this device, the outer joint part has engagement tabs on its face side that faces toward a connection flange of the shaft, which tabs can be pushed into and engaged in depressions in the outside circumference of the connection flange of the shaft.

A longitudinal shaft of this type is also described in German Patent No. DE 199 43 880 C1, in which the outer hubs of the joint on the transmission side and of the joint on the differential side each form flange connections, and the outer hubs of the joints are welded to the hollow shaft of the longitudinal shaft.

A longitudinal drive shaft and a constant velocity joint for motor vehicles, which are each connected with the outer part of the joint by way of flanges, are described in German Patent Nos. DE 43 44 177 C1 and DE 43 17 606 C1, whose outer hubs are structured as a sheet-metal formed part.

To simplify the structure and the configuration of a drive shaft in the form of a longitudinal shaft, is was proposed in German Patent No. DE 41 19 359 C2 to configure the longitudinal shaft in the form of a tubular shaft with connection regions configured at the ends, in which regions connection elements are coaxially disposed, which serve to accommodate and attach joints.

The production of these longitudinal shafts is labor intensive and particularly expensive. Furthermore, at the high speeds of rotation of the longitudinal shaft (up to 10,000 rpm) that often occur in operation, even slight imbalances of the longitudinal shaft as the result of insufficient centering lead to great centripetal forces in the longitudinal shaft, which lead to vibrations and disruptive noises.

### SUMMARY OF THE INVENTION

It is therefore an object of the present invention to provide a longitudinal shaft for motor vehicles, of the type stated, in which the joints to be disposed on the transmission side and on the differential side find accommodation directly in the tubular part of the longitudinal shaft, and the longitudinal shaft meets the technical requirements during operation.

The invention is based on the idea of producing a direct connection, by means of the configuration of the joints to be disposed relative to the tubular part of the longitudinal shaft, on the transmission side and on the differential side, thereby reducing the centripetal forces that occur as the result of imbalance, and thus increasing the comfort of the vehicle as the result of lesser vibrations and noises of the drive shaft configured as a longitudinal shaft.

Thus, the longitudinal shaft according to the invention consists of three essential functional modules. There is a tubular part, also called a hollow shaft, which is produced from a plastic, preferably from a fiber composite material. Joints are disposed on both sides in the tubular part of the longitudinal shaft, which joints are referred to as the joint on the differential side and the joint on the transmission side, in the following, this in turn resulting from the method of installation of the longitudinal shaft in a motor vehicle.

Both the joint on the transmission side and the joint on the differential side are disposed and attached in the tubular part of the longitudinal shaft by way of their outer hubs, so that a form that a torque-proof connection is formed between the outer hub and the inside wall of the tubular part. This ensures that a functionally reliable transfer of the torques that occur takes place. At the same time, it is ensured that a longitudinal shaft configured in accordance with the invention can be assembled, or also disassembled, between two transmissions of a motor vehicle, without problems.

The tubular part of the longitudinal shaft is configured with a thicker wall in the accommodation region of the joints as compared with the center part.

As explained above, the joints disposed in the tubular part are connected with the tubular part by way of their outer hubs, in torque-proof manner. In this connection, the arrangement and the connection of the inner parts of the joint on the differential side and of the joint on the transmission side take place in an inserted method of construction, at the same time, the combination possibilities of the configuration of a longitudinal shaft are significantly increased and improved.

The joints on the transmission side and on the differential side can be configured both as displacement joints and as fixed joints, and can be disposed in a longitudinal shaft in combined form, relative to one another.

Thus, according to the invention, longitudinal shafts having two displacement joints, or longitudinal shafts having one displacement joint and one fixed joint, or a longitudinal shaft having two fixed joints with displacement, can be produced.

The torque-proof connection between the outer hubs of the joints on the differential side and on the transmission side, relative to the tubular part, can be produced by means of a pressed connection or a glued connection, by means of which both a force-fit connection and a shape-fit connection between the joined components is created. The configuration of the torque-proof connections is not limited to the types of connections indicated, and other connection possibilities can also be used.

Sealing of the joint on the transmission side and on the differential side takes place, with regard to the interior of the tubular part of the longitudinal shaft, by way of lids provided in the outer hubs. The transmission is sealed off toward the outside by way of usual sealing systems, so that the lubricant grease present in the interior of the joints cannot exit unhindered, and foreign substances cannot penetrate into the interior of the joints.

The inclusion of a longitudinal shaft produced according to the invention in the drive system of a motor vehicle takes place by way of profilings provided in the inner hubs of the joints, in which the differential shaft or the transmission shaft, respectively, are joined directly or by way of a corresponding shaft journal that both possess the same profiling in the connection region as the inner hubs, and locked relative to one another by means of bracing screws.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a longitudinal shaft having a joint on the differential side, configured as a displacement joint, and a joint on the transmission side, configured as a fixed joint;

FIG. 2 shows a longitudinal shaft having a joint on the differential side and on the transmission side, which are configured as fixed joints with displacement; and

FIG. 3 shows a longitudinal shaft having a joint on the differential side and on the transmission side, which are each configured as displacement joints.

### DETAILED DESCRIPTION OF THE PREFERRED EMBODIMENT

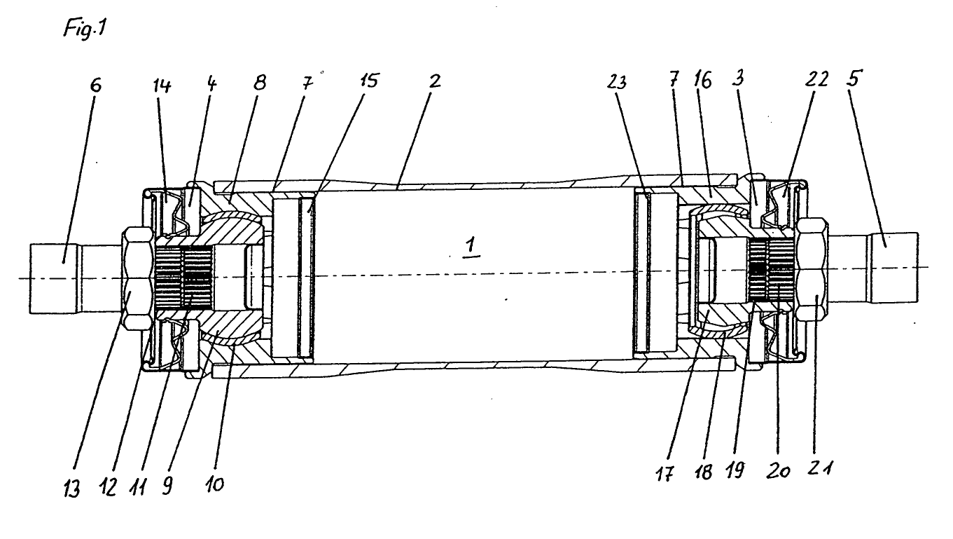

Referring now in detail to the drawings, the longitudinal shaft 1 shown in FIG. 1 consists of a tubular part 2 and joints 3, 4 disposed in tubular part 2 at both ends in torque proof manner, joint 3 on the differential side and joint 4 on the transmission side.

Joint 3 on the differential side is configured as a displacement joint, and joint 4 on the transmission side is configured as a fixed joint. Joint 3 on the differential side and joint 4 on the transmission side are inserted into tubular part 2 by way of their outer hubs 16, 8, and the torque-proof connection is achieved by means of a pressed connection, glued connection, or a similar shape-fit and force-fit connection between outer hubs 16, 18 and accommodation region 7 of tubular part 2, in each instance.

As is also shown in FIG. 1, tubular part 2 is configured with a greater wall thickness in its accommodation regions 7 at the two ends than in its center piece.

As is also evident from FIG. 1, joint 3 on the differential side consists of outer hub 16 and inner hub 17 joined with outer hub 16, and of balls guided in ball cage 18, which are guided in running grooves of outer hub 16 and inner hub 17.

Joint 3 on the differential side is sealed toward the interior of longitudinal shaft 1 by means of a lid 23, and toward the outside, by way of a seal 22.

The connection to differential shaft 5 takes place by way of shape-fit and force-fit connections, by way of profilings in the form of notched teeth, for example, which are provided on the outer circumference of differential shaft 5 and in the bore of inner hub 17.

Once differential shaft 5 is positioned relative to longitudinal shaft 1 after its assembly, these two parts are screwed together by way of a bracing screw 21.

Joint 4 on the transmission side, which is a fixed joint, consists of outer hub 8, inner hub 9, and the balls guided and positioned in ball cage 10. Both outer hub 8 and inner hub 9 are also configured with corresponding running grooves, in which the balls are mounted to be guided, whereby these functional parts are configured and joined relative to one another in such a manner that the joint 4 on the transmission side can be easily deflected.

The seal of joint 4 on the transmission side takes place, toward the interior of tubular part 2 of longitudinal shaft 1, by way of a lid 15 incorporated into outer hub 8 and, toward the outside, by way of seal 14 that is provided.

Inner hub 9 of joint 4 on the transmission side also possesses profilings 11 in its bore, for example notched teeth, with which transmission shaft 6 to be inserted is also configured, indicated with reference symbol 12 in FIG. 1.

Once transmission shaft 6 has been inserted in joint 4 on the transmission side and longitudinal shaft 1 has been positioned accordingly in terms of length, locking and bracing of these two parts takes place by way of bracing screw 13.

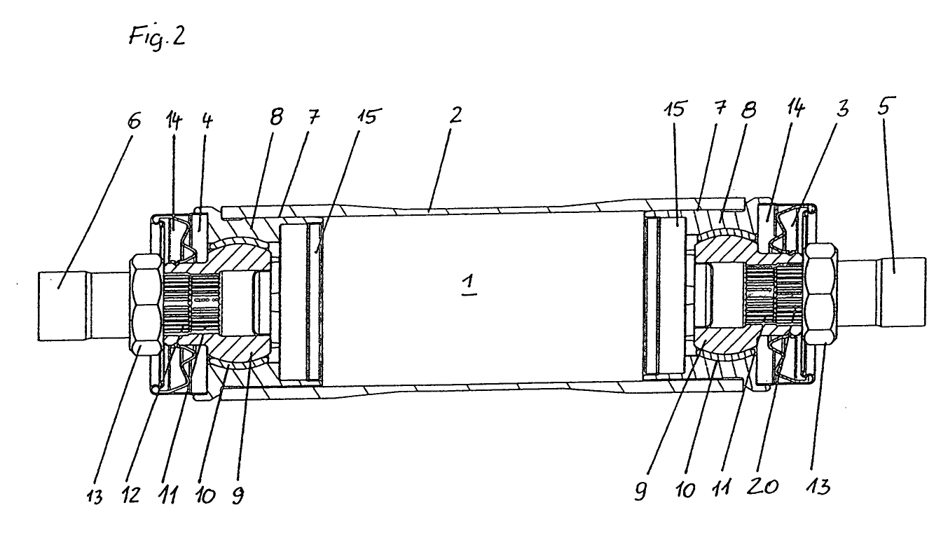

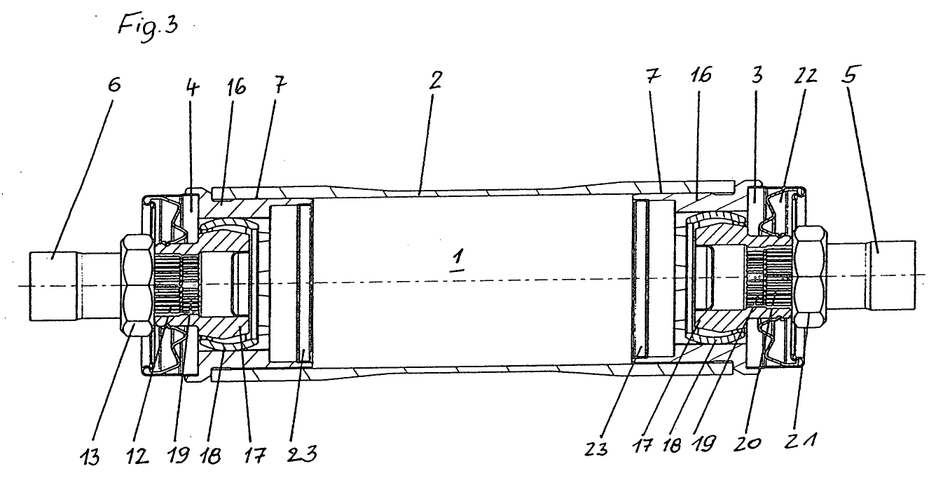

In FIGS. 2 and 3, the two other combination possibilities of the configuration of a longitudinal shaft 1 with two joints 3; 4 are shown.

Thus, the representation according to FIG. 2 relates to a longitudinal shaft 1 that is configured with fixed joints inserted in tubular part 2 at both ends. Both joint 3 on the differential side and joint 4 on the transmission side are configured as fixed joints that correspond to the fixed joint described as a joint 4 on the transmission side according to the previous embodiment shown in FIG. 1, in terms of their configuration, and have been described.

Another combination possibility for configuring a longitudinal shaft 1 according to the invention is shown in FIG. 3. Longitudinal shaft 1 shown here also consists and joint 3 on the differential side and joint 4 on the transmission side, disposed in both ends, respectively, of tubular part 2, in torque proof manner. Joints 3, 4 are configured as displacement joints in this embodiment of longitudinal shaft 1.

To avoid repetition, reference is made to the above explanations with regard to the structure and configuration of these two joints 3, 4.

The assembly of longitudinal shaft 1 between transmission shaft 6 or with a journal, not shown, and the differential shaft 5 takes place, for example, in such a manner that first, inner hub 9 of joint 4 on the transmission side is set onto transmission shaft 6.

Afterwards, differential shaft 5 or its shaft journal, which is not shown in the figures, is inserted toward inner hub 17 of joint 3 on the differential side, the parts are positioned relative to one another, and then bracing takes place by way of bracing screws 13 and 21.

Accordingly, while only a few embodiments of the present invention have been shown and described, it is obvious that many changes and modifications may be made thereunto without departing from the spirit and scope of the invention.

What is claimed is:

1. A longitudinal shaft for use in motor vehicles, comprising:
a tubular part;
a first joint disposed on a differential side, on one end of the tubular part, said one end accommodating a differential shaft; and
a second joint disposed on a transmission side, on another end of the tubular part, said another end accommodating a a transmission shaft;
wherein the two joints are disposed in accommodation regions on the two ends of the tubular part, by way of outer hubs of the joints in a torque-proof manner, and
wherein the joints are configured as fixed joints or displacement joints and are disposed in the tubular part in one of the following combinations:
two displacement joints,
one displacement joint and one fixed joint, or
two fixed joints with displacement.

2. The longitudinal shaft according to claim 1, wherein the torque-proof connections between the outer hubs of the joints and the accommodation regions of the tubular part are formed by a pressed connection or a glued connection.

3. The longitudinal shaft according to claim 1, wherein the first and second joints are structured so that the differential shaft and transmission shaft are inserted into inner hubs of the first and second joints, respectively.

4. The longitudinal shaft according to claim 1, wherein the tubular part is configured with a greater wall thickness in the accommodation regions of the joints, as compared with a center part of the tubular part.

5. The longitudinal shaft according to claim 3, wherein the inner hub of the joints are configured with profilings, into which the differential shaft and the transmission shaft, which are also configured with profilings, are joined, by bracing a respective joint and shaft relative to one another and attaching the joint and shaft with bracing screws.

6. The longitudinal shaft according to claim 1, wherein the joints are sealed, with regard to an interior of the tubular part by means of lids provided in the outer hubs of the joints.
